(19) United States
(12) Patent Application Publication
(10) Pub. No.: US 2021/0156255 A1
(43) Pub. Date: May 27, 2021

(54) TURBOMACHINE COMPRISING A DEVICE FOR IMPROVING THE COOLING OF ROTOR DISCS BY AN AIR FLOW

(71) Applicant: SAFRAN AIRCRAFT ENGINES, Paris (FR)

(72) Inventor: Christophe Scholtes, MOISSY-CRAMAYEL (FR)

(73) Assignee: SAFRAN AIRCRAFT ENGINES, Paris (FR)

(21) Appl. No.: 17/045,656

(22) PCT Filed: Apr. 2, 2019
(86) PCT No.: PCT/FR2019/050759

§ 371 Date: Oct. 6, 2020

(30) Foreign Application Priority Data
Apr. 13, 2018 (FR) 1853239

(51) Int. Cl. F01D 5/08

(52) U.S. Cl. CPC F01D 5/082; F05D 2220/323; F05D 2260/221

(57) ABSTRACT

An aircraft turbine engine includes at least one tubular element, such as a rotor shaft, and at least one rotor wheel extending around the tubular element and having a disk carrying at an external periphery of same, an annular row of blades, the disk extending at a radial distance h from the tubular element in such a way as to define an annular flow space for a cooling gas stream (Fr) during operation, wherein the tubular element includes at least one annular wall extending radially outwards and configured to divert the gas stream (Fr) in order for it to pass substantially radially between the disk and this annular wall.

### TECHNICAL FIELD

The present invention relates to aircraft turbine engines. It is aimed more particularly at controlling the clearances between the rotors and the static parts, in particular in the compressors and turbines, during the operation of the turbine engine.

### BACKGROUND

The prior art comprises in particular the documents WO-A1-2015/050680, US-A1-2016/069193, GB-A-836952 and US-A1-2016/024927.

In a compressor as well as in a turbine, the clearances at the top of the mobile wheel have a first-order influence on the efficiency of the engine. The clearances are mainly the consequence of mechanical and thermal phenomena.

The main mechanical phenomena are: the deformation of the rotor under centrifugal forces, the effects of duct pressures on the rotor and stator, axial displacements.

Regarding the thermal phenomena, we find the differential expansion of the component parts of the rotor and stator, in particular in the high pressure compressor. These parts generally have different coefficients of thermal expansion and especially a different deformation rate due to a different environment. In general, the stator parts, which are more ventilated and less massive, react more quickly than the rotor disk, whose inertia is mainly related to the mass of the disk root, which is poorly ventilated. This difference in thermal response time causes a strong opening of the operating clearances.

On some engines, the optimization of the efficiency means that the pressure gradient between the upstream and downstream of the engine that activates the flow rate of cooling air passing under the bore of the rotor disks may be small at low rpm. This results in a low flow rate of the cooling flow at the base of the rotor disks, which induces high response times at critical points for the clearances. The consequences are increased wear of abradable materials and increased clearances in cruising mode operation for the aircraft.

The purpose of the invention is to propose a solution to reduce the thermal response time of the rotor disks, in particular when the design of the engine involves a low flow rate of cooling air passing at the root of the rotor disks.

### DISCLOSURE OF THE INVENTION

The invention relates to an aircraft turbine engine, comprising at least one tubular element, such as a rotor shaft, and at least one rotor wheel extending around said tubular element and comprising a disk carrying on the external periphery of same, an annular row of blades, said disk extending at a radial distance h from said tubular element in order to define an annular flow space for a cooling gas stream during operation. Said tubular element comprises at least one annular wall extending radially outwards and configured to divert said gas stream in order for it to pass substantially radially between the disk and said annular wall.

The annular wall forces the flow exiting the constriction formed by the annular space between the disk and the tubular element to run radially along the wall of the disk. The constriction causes a local acceleration of the flow, thus increasing the heat exchange coefficients on the portion of the wall of the disk where the flow is accelerated. The annular wall forces the flow to have a radial component, before or after the annular space, thus to run along a part of the transverse wall of the disk. It therefore increases the exchange surface for the accelerated flow by narrowing the annular space, which improves heat transfer and thus reduces the clearances.

According to the invention, the annular wall is carried specifically by the tubular element, since an annular wall carried by the disk may present a risk of initiating and propagating cracks in the disk and reduce the service life of the disk.

Preferably, said annular wall is located downstream of said disk with respect to the direction of flow of said stream.

By forcing the flow coming out of the constriction to run radially along the disk, the exchange surface between the disk and an accelerated part of the gas stream is increased. This increases the cooling of the disk, which makes it possible to decrease its thermal inertia, thus improving the clearances around the rotor wheel comprising this disk.

If only one annular wall is placed behind the disk of a single rotor wheel, the one that is the most critical in terms of operating clearances is preferably chosen.

By modifying the flow structure, this device also has a beneficial effect on the cooling of the neighbouring wheel disks placed in the path of the same gas stream.

Advantageously, said annular space between the disk and the tubular element has a radial dimension h and said annular wall has a radial dimension H greater than h.

Thus, the passage of the cooling gas stream has, after the annular space between the disk and the tubular element, a disk-shaped portion between the rear wall of the disk and the annular wall from which the gas escapes radially.

Preferably, said annular space between the disk and the tubular element has a radial dimension h and said annular wall is located at an axial distance J from said disk, which is less than h.

The portion of the passage of the gas behind the disk of the wheel which is disk-shaped is in this case narrower than the annular passage, which, by forcing the gas to accelerate, increases the exchange coefficients. Advantageously, the axial distance J is defined in such a way that the Mach number of the air flow remains less than 0.3 in the annular space of the axial clearance.

Advantageously, said annular wall is integrally formed with said tubular element.

Advantageously, said disk comprises a central bulb comprising a substantially planar transverse wall extending opposite said annular wall up to a radial distance H2 from the tubular element, the radial extension H of the annular wall being substantially equal to H2.

Thus, the radial flow is forced to follow the entire transverse wall of the bulb, which is the most massive part of the disk.

Preferably, at least two consecutive wheel disks extend around said tubular element, said annular wall extending between the consecutive disks being closer to the upstream disk than to the downstream disk with respect to the direction of flow of said stream.

Surprisingly, the beneficial acceleration effect generated by the annular wall near the upstream disk extends up to the downstream disk.

Advantageously, at least one disk extends upstream of said disk with respect to the direction of flow of said stream, said upstream disk extending at a radial distance from said tubular element greater than the radial distance h between said disk and said tubular element.

By placing the annular wall at the disk radially closer to the tubular element, the annular wall is placed close to a neck for the flow of the cooling fluid and it can be seen that this results in a general acceleration around said disk, which retains a beneficial effect for the heat exchanges on the upstream disk.

According to another embodiment of the invention, said tubular element further comprises a second annular wall extending radially outwards and configured to divert said gas stream so that it passes substantially radially between the disk and this second annular wall.

Said second annular wall can extend between the consecutive disks by being closer to the downstream disk than to the upstream disk with respect to the direction of flow of said stream.

The downstream disk may comprise a central bulb comprising a substantially planar transverse wall extending opposite said second annular wall up to a radial distance H2′ from the tubular element, the radial extension H′ of the second annular wall being substantially equal to H2′.

The radial distance H2′ between the central bulb of the downstream disk and the tubular element may be greater than the radial distance H2 between the central bulb of the upstream disk and said tubular element.

The annular space between the downstream disk and the tubular element may have a radial dimension h′ and in that said second annular wall is arranged at an axial distance J′ from said downstream disk, which is less than h′.

The axial distance J′ of the second annular wall may be equal to or greater than the axial distance J of the annular wall.

Said tubular element may be a sleeve or a tie rod.

Said tubular element may belong to a first rotating body, e.g. low pressure, and said at least one disk may belong to a second rotating body, e.g. high pressure.

### BRIEF DESCRIPTION OF THE FIGURES

The present invention will be better understood and other details, characteristics and advantages of the present invention will appear more clearly on reading the following description, with reference to the annexed drawings on which:

FIG. 1 represents a half axial section of an engine concerned by the invention, between the high pressure compressor and the low pressure turbine.

FIG. 2 represents the contour of the axial half-section of a cavity representing schematically, for a compressor resembling that of FIG. 1, the radially inner space at the inner ends of the rotor disks, in which the cooling flow circulates.

FIG. 3 shows a detail of FIG. 2, at an obstacle located near bulbs located at the root of a disk.

FIG. 4 represents current lines of a cooling air stream in the cavity of FIG. 2, coming from a computational simulation,

FIG. 5 represents a partial and enlarged view of two obstacles located between two consecutive rotor disks according to a second embodiment of the invention.

The elements of the turbine engine having the same functionalities on the figures are referenced with the same numbers.

### DESCRIPTION OF AN EMBODIMENT OF THE INVENTION

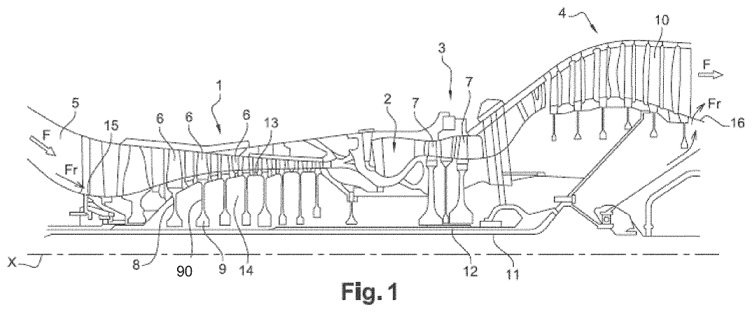

FIG. 1 represents a part of the elements of the turbine engine through which the primary stream passes, in particular the high-pressure body followed by the low-pressure turbine. The high-pressure body here comprises a high-pressure compressor 1, a combustion chamber 2 and a high-pressure turbine 3. The gas of the primary stream F leaving the high-pressure turbine 3 drives the low-pressure turbine 4. The primary stream F arrives in the high-pressure compressor 1 through an annular duct 5 which generally connects it to a low-pressure compressor placed upstream, not shown here. The high-pressure compressor 1 comprises several rotor wheels 6 secured to the rotor wheels 7 of the high-pressure turbine 5 and rotating at a given speed ω1 around the axis X of the engine.

The rotor wheels 6 of the high-pressure compressor 1, in particular, each have a disk 8 that carries on the periphery of same, an annular row of blades working in the primary stream F. The disk 8 of each rotor is recessed in its centre and generally comprises an annular bulb 9 surrounding the central orifice. The centre of gravity of the rotor wheels 6 is thus close to the axis of rotation X, but the disks 8 have a high thermal inertia due to the mass of their central bulb 9.

The rotor wheels 10 of the low-pressure turbine 4 rotate at a different speed from the rotational speed ω1 of the rotor wheels 6 of the high-pressure body. They drive a low-pressure shaft 11 which passes through the high-pressure body radially inside the central bulb 9 of the disks 8 of the rotor wheels 6 of the high-pressure body, in order to drive elements not shown upstream, for example the low-pressure compressor. Here, at the high-pressure compressor 1, the low-pressure shaft 11 is surrounded by a sleeve 12 or a tie rod which insulates it. In general, said sleeve 12 rotates at the same speed as the low-pressure shaft 11 and is essentially in the form of a cylinder of constant diameter, smaller than the internal diameter of the bulbs 9, so as to leave an axial annular passage.

The successive rotor wheels 6 of the high-pressure compressor 1 delimit, on the periphery of their disks 8, the outer wall 13 of an annular cavity 14 which is located radially below the primary flow duct F. The radially inner wall of the cavity 14 is defined by the sleeve 12 which rotates here at a speed different from that ω1 of the disks 8a to 8d, for example at the speed of the low-pressure body. A cooling air flow Fr of the disks 8 of the rotor wheels 6 circulates in this annular cavity 14. The circuit of this cooling flow has an inlet 15 corresponding to a sampling in the primary stream F in the duct 5, upstream of the high-pressure compressor 1. Downstream, the circuit has an outlet 16 forming an exhaust in the primary circuit F, behind the low-pressure turbine 4.

The flow rate of the cooling air Fr which circulates from upstream to downstream in this circuit by passing through successive annular cavities, including that 14 described above, is a positively sloping function of the pressure difference between the inlet 15 and the outlet 16. The cooling efficiency of the disks 8 of the rotor wheels 6, especially in the compressor 1, increases if the cooling air flow rate Fr increases. On the other hand, the pressure losses created by the obstacles in the circuit limit the cooling air flow rate.

In particular, the disk 8 of each rotor wheel 6 therefore consists of a bulb-shaped root 9 and an annular portion 90 (also known as the “annular web”). The bulb 9 is arranged in the cavity 14 on the side of the sleeve 12. The cavity 14 comprises an annular space, of smaller diameter, delimited by the bulb 9 and the sleeve 12, with a radial distance h. The annular web 90 extends substantially transversely from an external wall 13, on the periphery of the disk, towards the annular space. The annular web 90 is configured to support the annular row of blades. The bulb 9 is integral with the annular web 90.

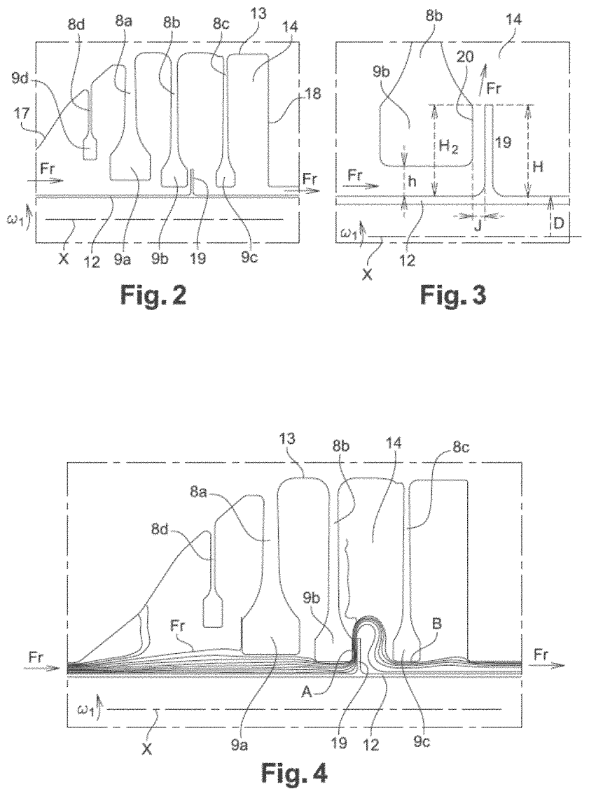

An embodiment of the invention is schematically shown in FIGS. 2 and 3 to improve the heat exchange coefficient between the cooling air Fr and one or more rotor disks 8. The cavity 14 shown in these figures is a schematic representation of the one shown in a high pressure compressor 1 in FIG. 1, in order to carry out numerical simulations to evaluate the phenomena. Here, we consider a cavity 14 with the rotor disks 8a, 8b, 8c and 8d. The annular cavity 14 is limited radially outwards by the wall 13 formed by elements carried by the rotor disks 8a to 8d, close to their periphery. An upstream wall 17 and a downstream wall 18, rotating at the same speed ω1 as the disks 8a to 8d, axially close the annular cavity 14 leaving an annular inlet opening and an annular outlet opening for the cooling air Fr. The outer diameters of the inlet and outlet openings are of the same order as the diameters of the central openings in the bulbs 9a-c of the disks 8a-c. The external wall 13 comprises a variable diameter depending on the position of the disk 8 with respect to the air flow Fr. In FIG. 2, the diameter of the external wall 13 increases gradually from the disk 8d near the upstream wall 17 and up to the disk 8c near the downstream wall 18. The maximum diameter of the external wall 13 is therefore very large with respect to the diameter of the central openings in the bulbs 9a to 9d of the disks 8a to 8d. Here, the disk 8b is the one with the minimum opening, it is in particular smaller than that of disk 8a, upstream, and disk 8c, downstream.

The radially inner wall of the annular cavity 14 is formed by the sleeve 12. Its shape is that of a cylinder of a given radius D, passing through the cavity 14 from its inlet to its outlet and carrying on its surface an annular obstacle 19 in the form of a disk of radial extension H, placed here behind the third disk 8b, starting from the inlet. Said annular obstacle 19 is integral with the sleeve 12, and is therefore driven in rotation with it.

The sleeve 12 and the rotor disks 8a-c separate the cavity 14 into a series of sub-cavities connected by narrow annular passages provided between the bulbs 9a-c and the sleeve 12, passages in which the cooling air Fr is accelerated and the exchange coefficient is high. The air circulating in the annular cavity therefore cools the bulbs 9a-c of the disks 8a-c as a priority, which is desirable since these are the most massive parts of the disks.

With reference to FIG. 2, the difference in diameter between the central opening of the bulb 9b of the third disk 8b defines an annular passage around the sleeve 12 with a radial extension h equal to the difference in diameters.

In the example of FIGS. 2 and 3, the disk-shaped obstacle 19 is placed behind the third rotor disk 8b at a small axial distance J from the rear transverse wall of the bulb 9b. Alternatively, the obstacle could be placed indifferently behind each of the disks of the HP compressor. The radial extension H of the disk of the obstacle 19 on the cylindrical wall of the sleeve 12 is greater than the radial extension h of the annular passage between the sleeve 12 and the central bulb 9b of the disk 8b. The disk-shaped obstacle 19 thus creates a radial passage behind the central bulb 9b of the disk 8b, in which the cooling air stream Fr escapes radially by grazing the rear transverse wall of the bulb 9b of the disk 8b.

Preferably, the axial clearance J between the disk of the obstacle 19 and the rear wall of the bulb 9b of the disk 8b is smaller than the radial thickness h of the annular space between the bulb 9b and the sleeve 12. In particular, the axial clearance J of the obstacle 19 is between ¼ and 1/10 of the radial distance H2 of the obstacle, while ensuring that the axial clearance J does not exceed the radial thickness h of the annular space between the bulb 9b and the sleeve 12. In FIG. 3, the obstacle 19 is arranged with an axial clearance J of substantially ⅕ of the radial distance H2. In this way, the radially escaping air is accelerated and cools the central bulb 9b more efficiently.

In the example, the central bulb 9b is limited axially by a planar transverse wall 20 which extends radially up to a distance H2 from the sleeve 12. Advantageously, the radial extension H of the disk of the obstacle 19 is substantially equal to the distance H2, so that a radial exhaust gap of the cooling air is formed, forming a disk that runs along the transverse wall 20. Thus, the flow rate of accelerated air cools a maximum portion of the central bulb 9b of the disk 8b.

FIG. 4 illustrates the phenomenon obtained by showing current lines of the cooling air flow Fr obtained by calculation on the configuration of FIGS. 2 and 3. The concentration of the lines at points A and B shows that the heat exchanges are important for the third rotor disk 8b but also for the following disk 8c.

The calculation result also shows that the presence of the obstacle 19 does not disrupt the upstream flow, which continues to correctly cool the preceding disk 8a. It should be noted here that the radial distance from the disk 8a to the sleeve 12 is smaller than the radial distance h from the disk 8b to the sleeve 12. The disturbance of the flow by the obstacle 19 is therefore made at the level of a neck for the path of the cooling flow Fr.

This example of embodiment shows that the presence of the obstacle 19 does not strongly increase the pressure losses and thus makes it possible to increase the exchange coefficients with the rotor disks 8a-c by accelerating the air stream Fr near the central bulbs 9a-c of the latter. The rotation speed of the obstacle 19 embedded on the sleeve 12 is different from the rotation speed of the disks 8a to 8d which rotate for example at the speed of the low pressure body. This rotational speed differential influences favourably the result with regard to the flow pressure losses in the axial clearance of value J.

The inventors' calculations show, however, that in order to minimize the pressure losses, two conditions should preferably be met with regard to the axial clearance J.

The first condition, described above, is that the axial clearance J is smaller than the radial thickness h of the annular space between the bulb and the sleeve.

The second condition is that the Mach number of the air flow remains less than 0.3 in the annular space of the axial clearance J.

For this condition the quantity K=R*T/γ is defined, where R is the perfect gas constant, T is the temperature of the air at the axial clearance J and γ is the Laplace coefficient or adiabatic index. According to this second condition, the cross-sectional passage through the axial clearance J must remain less than the square root of the quantity K, multiplied by the cooling air flow rate Fr in cavity 14 and divided by 0.3 times the air pressure at the axial clearance J.

The position of the obstacle 19 in FIGS. 2 to 4 shows a good compromise between the increase in exchange coefficients for the rotor disks 8a-c in the configuration shown. However, the invention is not limited to the presented configuration. One can vary the dimensions of the obstacle 19 based on the considerations indicated above, or even put obstacles behind several disks. The choice of the number of obstacles, their size and positioning will depend on the configuration of the turbine engine and the compromise sought.

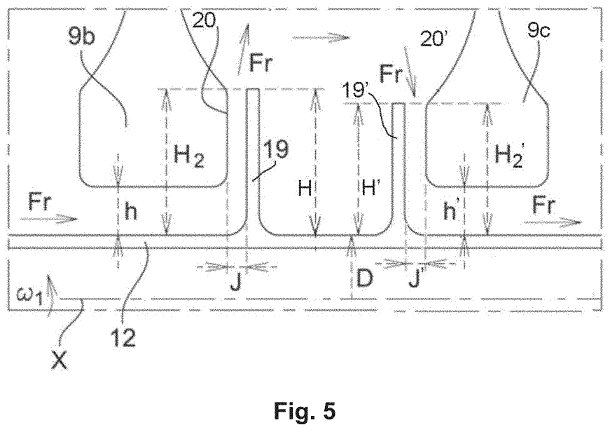

FIG. 5 illustrates a second embodiment, in which two obstacles 19, 19′ are carried by the sleeve 12 and extend radially outwards between two consecutive disks, respectively upstream disk 8b and downstream disk 8c. The first obstacle 19 corresponds to the obstacle described above, i.e. it is placed at an axial clearance J behind the rear transverse wall 20 of the upstream bulb 9b with the radial distance H2 from the sleeve 12. This radial distance H2 from the rear transverse wall 20 corresponds to the radial distance H of the first obstacle 19. The second obstacle 19′ is arranged substantially at one axial clearance J′ in front of the front transverse wall 20′ of the downstream bulb 9c. This front transverse wall 20′ extends radially up to a distance H2′ from the sleeve 12. Advantageously, the radial extension H′ of the second obstacle 19′ is substantially equal to the distance H2′, so as to form a radial exhaust gap of the cooling air forming a disk which runs along and is flush with the front transverse wall 20′ of the downstream disk 8c. These two obstacles allow the accelerated air flow rate to cool a maximum portion of both the upstream bulb 9b and the downstream bulb 9c.

Advantageously, the downstream bulb 8c extends at a radial distance h′ from the sleeve 12 that is greater than the distance h between the upstream bulb 9b and the sleeve 12, so that the distance H2 of the rear transverse wall 20 of the bulb 9b is greater than the distance H2′ of the front transverse wall 20′ of the downstream bulb 9c. Therefore, the distance H of the first obstacle 19 is greater than the distance H′ of the second obstacle 19′.

Preferably, the axial clearance J′ of the second obstacle 19′ is at least equal to the axial clearance J of the first obstacle 19. For example, the axial clearance J′ is similar to or greater than two to four times the axial clearance J, while ensuring that the axial clearance J′ does not exceed the radial thickness h′ of the annular space between the bulb 9c and the sleeve 12. In FIG. 5, the axial clearance J of the first obstacle 19 is identical to the axial clearance J′ of the second obstacle 19′. In this way, the radially escaping cooling air stream Fr is also re-accelerated and cools more efficiently the downstream bulb 9c of the downstream disk 8c.

The use of two obstacles between two consecutive disks increases the heat exchange coefficient simultaneously by two consecutive disk wall portions where the flow is accelerated, so as to improve the clearances at the top of the sleeve. This also allows to further reduce the thermal response time of the upstream 9b and downstream 9c disks, while generating little associated pressure losses.

1. An aircraft turbine engine, comprising:
at least one tubular element; and
at least one rotor wheel extending around the tubular element and comprising a disk carrying at an external periphery, thereof an annular row of blades, the disk extending at a radial distance h from the tubular element in such a way as to define an annular flow space for a cooling gas stream (Fr) during operation, the tubular element comprising at least one annular wall extending radially outwards and configured to divert the cooling gas stream (Fr) to pass radially between the disk and the annular wall;
wherein the disk comprises a central bulb comprising a planar transverse wall extending opposite the annular wall up to a radial distance H2 from the tubular element, the radial extension H of the annular wall being equal to H2.

2. The turbine engine according to claim 1, wherein the annular wall is located downstream of the disk with respect to a direction of flow of the cooling gas stream (Fr).

3. The turbine engine according to claim 1, wherein the annular space between the disk and the tubular element has a radial dimension h and in that the annular wall has a radial dimension H greater than h.

4. The turbine engine according claim 1, wherein the annular space between the disk and the tubular element has a radial dimension h and in that the annular wall is located at an axial distance J from the disk, wherein J is less than h.

5. The turbine engine according to claim 1, wherein the annular wall is integrally formed with the tubular element.

6. The turbine engine according to claim 1, wherein the disk is an upstream disk of at least two consecutive wheel disks extending around the tubular element, the annular wall extending between the at least two consecutive disks being closer to the upstream disk than to a downstream disk of the at least two consecutive wheel disks with respect to a direction of flow of the cooling gas stream (Fr).

7. The turbine engine according to claim 6, wherein at least one second upstream disk extends upstream of the upstream disk with respect to the direction of flow of the cooling gas stream (Fr), the second upstream disk extending at a radial distance from the tubular element greater than the radial distance h between the upstream disk and the tubular element.

8. The turbine engine according to claim 6, wherein the tubular element further comprises a second annular wall extending radially outwards and configured to divert the cooling gas stream (Fr) so that it passes radially between the downstream disk and the second annular wall.

9. The turbine engine according to claim 8, wherein the second annular wall extends between consecutive disks being closer to the downstream disk than to the upstream disk with respect to the direction of flow of the stream (Fr).

10. The turbine engine according to claim 8, wherein the downstream disk comprises a central bulb comprising a planar transverse wall extending opposite the second annular wall up to a radial distance H2′ from the tubular element, the radial extension H′ of the second annular wall being equal to H2′.

11. The turbine engine according to claim 10, wherein the radial distance H2′ is greater than the radial distance H2.

12. The turbine engine according to claim 9, wherein the annular space between the downstream disk and the tubular element has a radial dimension h′ and in that the second annular wall is arranged at an axial distance J′ from the downstream disk, wherein J′ is smaller than h′.

13. The turbine engine according to claim 12, wherein J′ is equal to or greater than an axial distance J between the annular wall and the disk.

14. The turbine engine according to claim 1, wherein the tubular element is a sleeve or a tie rod.

15. The turbine engine according to claim 1, wherein the tubular element is part of a first rotating body and the at least one disk is part of a second rotating body.
